(19) United States
(12) Patent Application Publication
(10) Pub. No.: US 2004/0220852 A1
(43) Pub. Date: Nov. 4, 2004

(54) System and method for rewarding performance

(76) Inventor: Ivan Miles Posey, Coto de Caza, CA (US)

Correspondence Address: Ivan M. Posey, 1 Fair Valley, Coto de Caza, CA, 92679, US

(21) Appl. No.: 10/426,759

(22) Filed: Apr. 30, 2003

(51) Int. Cl. G06F 17/60

(52) U.S. Cl. 705/14; 705/11

(57) ABSTRACT

A matchmaking system providing a method for rewarding likableness on a date is disclosed. A first subsystem is for tracking compensation accepted from a first customer of the matchmaking service system for the system's matching or referring of one or more second customers of the matchmaking service system for a date. A second subsystem provides for the receiving of a rating from the first customer regarding the likableness of the second customer. A third subsystem is for providing a portion of the compensation from the first customer to the second customer, the size of the portion provided to the second customer depending on the rating received from the first customer. A system for providing incentives or rewards for high ratings from customers in the performance of business services is also disclosed. In that context, the first subsystem is used for tracking compensation accepted from a customer for referring a person or entity to perform services. The second subsystem is for receiving a rating from the customer regarding the performance of services. The third subsystem is for providing a portion of the compensation to the person or entity, the size of the portion depending on the rating.

### BACKGROUND OF THE INVENTION

The present invention relates generally to a system and method for rewarding performance in a service or dating referral system. More particularly, and although not exclusively, the present invention relates to a system and method for providing incentive for a referred person or entity to better perform services in a paid for business referral service, and a system and method for rewarding social likableness on a date in a dating or matchmaking service.

Traditional dating and matchmaking services suffer from the same disadvantages as general referral services, such as employment agencies. While persons patronizing these referral services and agencies may have a natural incentive to perform well, or in the case of dating, impress the other person socially, there is not much more of an incentive to perform well or behave socially. Even in the case of an employment agency or other business referral service where the person or entity performing business services may receive pay, there may not be an additional incentive to perform better than what is minimally required to perform the business services. In most cases, customers of the agency or referral service often desire a quality of service that is above what is considered minimal, whereas prior art referral services do not encourage the people or agencies financially to provide that extra quality.

In the context of dating services, especially where one customer simply does not like the other customer that they are matched with, there is little added incentive to try to socially impress the other person on a date. This is not to suggest that a person should seek to fallaciously impress a person with whom they are matched on a date if they genuinely do not like that person. However, especially in such a situation, each person should at least be encouraged to socialize with the other person cordially during the date so that neither has a particularly unpleasant experience on the date. On the other hand, even when the matched persons have the potential to like each other, sometimes one or each of them in their nervousness are less affable on a date. However, with added incentive, each person may behave more affably despite his or her nervousness, and each may find out that they do indeed like the other person once there is more social interaction. Current matchmaking systems do not offer such an incentive.

### BRIEF SUMMARY OF THE INVENTION

The above shortcomings in dating services and general referral services are resolved by the present invention. In one context, a matchmaking system providing a method for rewarding likableness on a date is disclosed. A first subsystem is for tracking compensation accepted from a first customer of the matchmaking service system for the system's matching or referring of one or more second customers of the matchmaking service system for a date. A second subsystem provides for the receiving of a rating from the first customer regarding the likableness of the second customer. A third subsystem is for providing a portion of the compensation from the first customer to the second customer, the size of the portion provided to the second customer depending on the rating received from the first customer.

A system for providing incentives or rewards for high ratings from customers in the performance of business services is also disclosed. In that context, the first subsystem may be used for tracking compensation accepted from a customer. The compensation is accepted by the first subsystem for referring a person or entity to perform services. The second subsystem may be for receiving a rating from the customer regarding the performance of services. The third subsystem may be for providing a portion of the compensation to the person or entity, the size of the portion depending on the rating.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a high-level architectural drawing illustrating the primary components of a matchmaking system that operates in accordance with the present invention;

FIG. 2 is a performance tracking database table used by the system of FIG. 1; and

FIG. 3 is a flow diagram of a generic method that can be used to operate the matchmaking system of FIG. 1 or other generic or business referral systems that can operate on the system of FIG. 1.

### DETAILED DESCRIPTION OF THE PREFERRED EMBODIMENTS

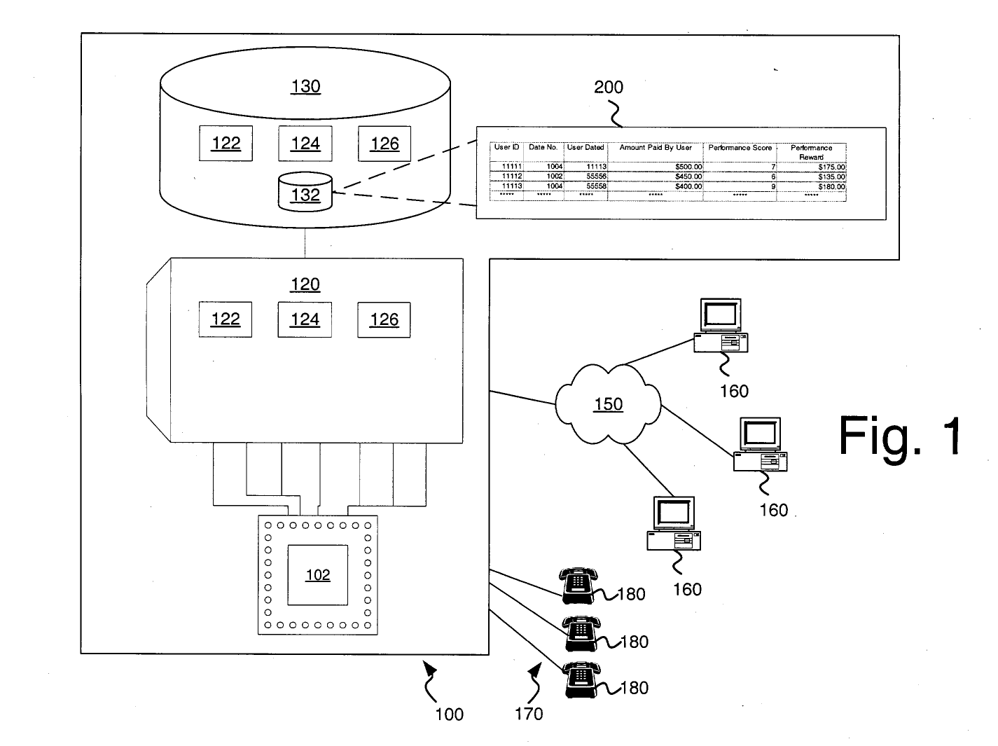

With reference to FIG. 1, a high-level architectural drawing illustrating the primary components of an embodiment of a matchmaking system 100 according to the present invention is shown. The matchmaking system 100 performs a method for rewarding likableness on a date. The matchmaking system 100 may comprise a generic data processing system such as a personal computer comprising a central processing unit 102. However, system 100 may comprise a variety of different computing platforms such as mid-range or large mainframe computing systems. The processor 102 may use reduced instruction set or complex instruction set technology.

In the embodiment of FIG. 1, the matchmaking system 100 includes several subsystems 122-126, which are each comprised of executable software instructions for executing using the central processing unit 102. After programming or installation on the matchmaking system 100, the subsystems 122-126 are stored on a storage device 130 which may comprise, for example, a mass storage device or solid-state non-volatile storage device such as hard disk or safe-RAM. As each subsystem is needed for operation of the matchmaking system 100, the appropriate subsystems 122-126 may be loaded into a system memory 120, which may comprise, for example, higher-speed volatile storage 120 such as a system random access memory (RAM) or the like. Those skilled in the art would recognize that the system 100 shown in FIG. 1 may comprise a personal computer or server computer running the WINDOWS NT or 2000 operating system by the Microsoft Corporation of Redmond Wash., storing and executing the subsystems 122-126.

Also included may be a comprehensive matchmaking database 132 for providing known matchmaking capabilities for users of the matchmaking system 100. One example of such a database 132 is shown and described in U.S. Pat. No. 6,061,681. Described in that patent is a database for implementing a system for matching people with each other. The database stores user information to match a particular user with at least one other user of the system. Those skilled in the art would recognize that other matchmaking database systems may implemented for database 132, such as that provided for YAHOO PERSONALS by Yahoo!, Inc. of Sunnyvale, Calif. With each of these and other databases that may comprise database 132 uses, the database may be to updated and read via one or more user computers 160 connected to a network 150, such as the Internet, to access server pages produced by the system 100. In some embodiments, the database 132 may be updated and read by users via one or more telephones 180 connected via the telephone network 170, the matchmaking system 100 further comprising a voice response system for receiving voice or keypad input as is commonly used, for example, in many customer service and airline flight reservation and tracking systems.

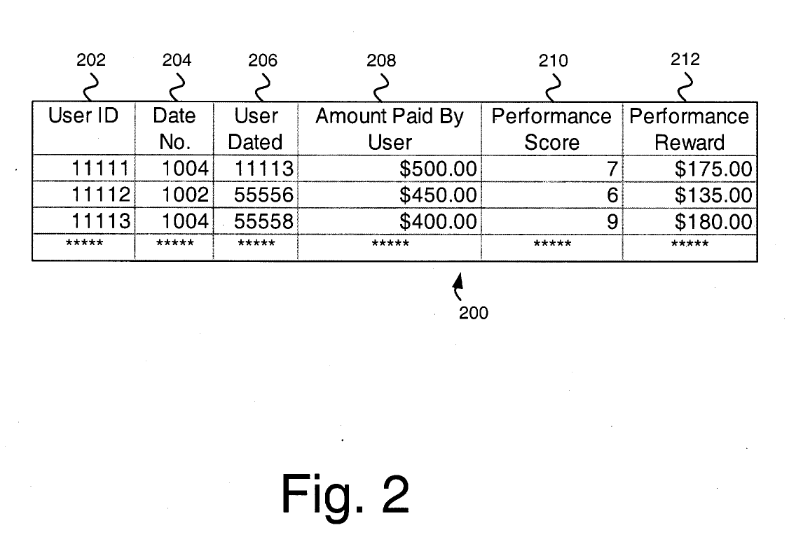

Also included in the database 132 are one or more performance tables 200 for keeping track of performance reward data for each date as explained in more detail with reference to FIG. 2 below.

The first subsystem 122 is for tracking compensation accepted from a first customer of the matchmaking service system 100 for the system's matching or referring of one or more second customers of the matchmaking service system 100 for a date. The compensation paid by the first customer is stored in the performance table 200.

The second subsystem 124 provides for the receiving of a rating from the first customer regarding the likableness of the second customer. Subsystem 124 may utilize, for example, Internet page access using the user computers 160 or telephone voice-response access using the telephones 180 as referred to above.

The third subsystem 126 is for providing a portion of the compensation from the first customer to the second customer, the size of the portion provided to the second customer depending on the rating received from the first customer. The rating, for example, may be based on a scale of 0-10, with 10 representing that the first customer thought that the second customer was an excellent social or dating companion, and for example, the first customer would like to have another date with the second customer if the second customer would like to do so, with 0 representing that the first customer thought that the second customer was the worst possible social or dating companion, and, for example, the first customer would not like to have another date with the second customer. In other words, the rating received from the first customer may gage the likableness of the second customer as demonstrated by the second customer on the date.

With reference to FIG. 2, an example performance table 200 that may be used by the embodiment of the system 100 of in FIG. 1 is shown. In the example table 200 of FIG. 2, the records are organized by each date participated in by two customers. Each customer of the matchmaking system 100 may be tracked using a unique customer identification number (customer ID) assigned to each customer of the matchmaking system 100. For each date, a user ID field 202 of table 200 stores the first customer's unique customer ID who participated in the date for each particular record. A date number field 204 stores a unique date number used by the matchmaking system 100 for tracking each date participated in by two customers. A user dated field 206 stores the customer ID of the second customer who participated in the date.

A amount paid by user field 208 stores the compensation accepted from a first customer identified in field 202 for the system's matching or referring of the second customer identified in field 206 for the date identified in field 204. In many dating services, customers pay a certain amount for a guaranteed certain number of referrals. In other dating services, customers pay for each actual referral. The first subsystem 122 handles either such case, or any other compensation scheme which may be used for the matchmaking system 100. For example, in FIG. 2, the customer identified by customer ID 11111 may have paid $1,500 for a total of 3 guaranteed referrals for dates. The first subsystem calculates that the customer paid $500 for each referral, and thus, that amount is entered into field 208 as the amount of compensation accepted by the system 100 for the particular date represented by date number 1004 shown in field 204. Further, some customers may have paid less to join the matchmaking service 100, or have taken advantage of special discounts offered to pay for further referrals, which explains the varying amounts of compensation shown between the records in field 208.

After the date, when the second subsystem receives a rating from the first customer, the rating is entered into a performance score field 210. Once the rating is entered into field 210, the third subsystem 126 may then automatically calculate the portion of the compensation in field 208 to be provided to the second customer based on the rating and enter that portion into a performance reward field 212. Standard security and password protection procedures may be used by the third subsystem 126 to make sure that the first customer is truly the customer providing the rating, such as a combination of the customer ID and a unique password selected or provided to the first customer.

There are various ways to calculate the portion of the compensation that is the performance reward based on the rating entered. For example, the calculation used in FIG. 2 takes half of the compensation entered in field 208, and multiplies the result by 0.1 times the rating in the performance score field 210. This method provides 5 percent of the compensation provided by the first customer to the second customer for each point or rating received from the first customer. This method of calculation provides for one form of a generous but reasonable percentage of the compensation paid by the first customer to the second customer to provide an incentive to the second customer to be more social, interactive or pleasant on the date. In other words, the portion of the compensation provides a dating performance reward to the second customer. However, other formulas or methods of calculation may be used other than the straight-line method illustrated, including graduated or curved scales.

The performance incentive may work both ways. For example, in the first record with customer ID 11111 in the user ID field 202 and date number 1004 in the date number field 204, the second customer being rated by the first customer is identified by customer ID 11113 as shown in the user dated field 206. As shown in the third record with customer ID 11113 in the user ID field 202 and the same date number 1004 in the date number field 204, the second customer rates the first customer for the same date. At least in some cases in the illustrated embodiment, the first subsystem 122 is further for tracking compensation accepted from the second customer; the second subsystem 124 is further for receiving a rating from the second customer regarding the likableness of the first customer; and the third subsystem 126 is further for providing a portion of the compensation from the second customer to the first customer, the size of the portion provided to the first customer depending on the rating from the second customer.

It should be noted that in some embodiments of the matchmaking system 100, it is not necessary that all or any of the steps be performed using a processor or computer programs. The first, second and third subsystems 122-126 of the matchmaking system 100 may each individually be of a type selected from the group consisting of: a ledger, a computerized accounting system, a database system, an on-line server connected to a network, an HTML system, an internet matchmaking system, a computerized spreadsheet and software based matchmaking system. For example, in a manual system embodiment, the table 200 of FIG. 2 may comprise paper-based ledger wherein the data is manually entered by a matchmaking agency. The ratings are received by the matchmaking agency in person or over the telephone. Checks are manually cut to send to the deserving customers after their performance rewards are calculated by hand or using a calculator. In the other extreme, in a highly computerized embodiment of the matchmaking system 100, after the performance award is calculated, the system 100 may send a signal to a bank where an account is kept for the system 100 to automatically print a check to send to the second customer in the amount of the performance reward. Various levels of human verification may be added before such a transaction is ordered, but those skilled in the art would recognize that such electronic transactions are common, and may also include electronic transfers of funds if the second customer provides their bank account information. In another embodiment, computerized spreadsheet system such as EXCEL by the Microsoft Corp. of Redmond, Wash. is used for table 200.

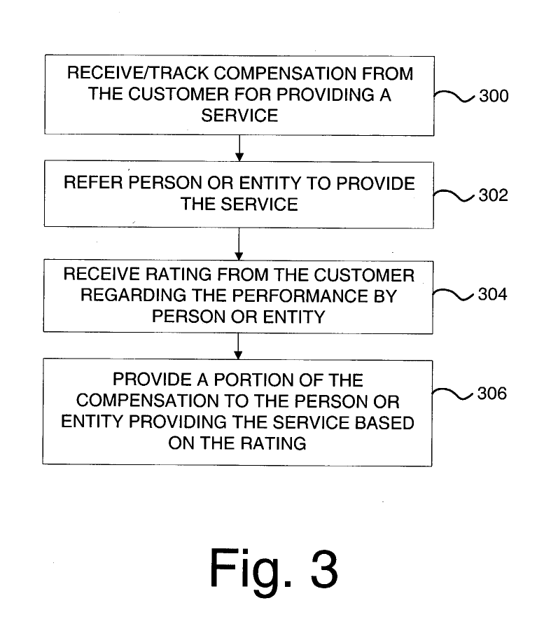

While the above system 100 of FIG. 1 is described to implement a dating or matchmaking service, the system 100 may be used to provide a generic system for rewarding performance in other contexts. For example, the system 100 may provide incentives or rewards for high ratings from customers in the performance of business services. In that regard, reference is made to FIG. 3, which illustrates a flow chart regarding a generic method that can be performed by the system 100 of FIG. 1. For example, the first subsystem 122 may be used for tracking compensation accepted from a customer, step 300. The compensation is accepted by the subsystem 122 for referring a person or entity to perform services, which may comprise, for example, business services, step 302. The second subsystem 124 may be for receiving a rating from the customer regarding the performance of services, step 304. The third subsystem 126 may be for providing a portion of the compensation to the person or entity, the size of the portion depending on the rating, step 306.

Employment agencies may use this method. In that context, the customer is an employer, the person or entity is an employee, and the services are the services performed by the employee for the employer. The employment agency referring the employee to the employer provides the performance reward to the employee based on the rating received from the employer.

A general contractor may use this method. The services may comprise subcontracted services performed by a subcontractor for the customer. The general contractor similarly provides a performance reward to the subcontractor based on a rating received from the customer.

Although the invention has been described in terms specific types of elements, as well as with reference to certain methodological acts, it is to be understood that the invention defined in the appended claims is not necessarily limited to the specific structures or acts described. The specific structural features and acts therefore are disclosed as exemplary embodiments implementing the claimed invention.

Further, the embodiments described above are provided by way of illustration only and should not be construed to limit the invention. Those skilled in the art will readily recognize various modifications and changes that may be made to the present invention without following the exemplary embodiments and applications illustrated and described herein, and without departing from the scope of the present invention, which is set forth in the following claims.

What is claimed is:

1. A method for rewarding performance, comprising:
accepting compensation from a customer for referring a person or entity to perform services;
receiving a rating from the customer regarding the performance of services; and
providing a portion of the compensation to the person or entity, the size of the portion depending on the rating.

2. The method of claim 1, wherein the services comprise duties performed by an employee for the customer, the customer providing the compensation to an employment agency, the employment agency providing the portion to the employee.

3. The method of claim 1, wherein the services comprise subcontracted services performed by subcontractor for the customer, the customer providing the compensation to a general contractor, which provides the portion to the subcontractor.

4. In a matchmaking system, a method for rewarding likableness on a date, comprising:
accepting compensation from a first customer of the matchmaking service for referring a second customer of the matchmaking service for a date;
receiving a rating from the first customer regarding the likableness of the second customer; and
providing a portion of the compensation from the first customer to the second customer, the size of the portion provided to the second customer depending on the rating from the first customer.

5. The method of claim 3, further comprising accepting compensation from the second customer; receiving a rating from the second customer regarding the likableness of the first customer; and providing a portion of the compensation from the second customer to the first customer, the size of the portion provided to the first customer depending on the rating from the second customer.

6. A matchmaking system for rewarding likableness on a date, comprising:
a first subsystem for tracking compensation accepted from a first customer of the matchmaking service for referring a second customer of the matchmaking service for a date;
a second subsystem receiving a rating from the first customer regarding the likableness of the second customer; and
a third subsystem for providing a portion of the compensation from the first customer to the second customer, the size of the portion provided to the second customer depending on the rating from the first customer.

7. The system of claim 6, wherein the first subsystem is further for tracking compensation accepted from the second customer; wherein the second subsystem is further for receiving a rating from the second customer regarding the likableness of the first customer; and wherein the third subsystem is further for providing a portion of the compensation from the second customer to the first customer, the size of the portion provided to the first customer depending on the rating from the second customer.

8. The system of claim 6, wherein the first, second and third are each part of a matchmaking system of a type selected from the group consisting of: a ledger, a computerized accounting system, a database system, an on-line server connected to a network, an HTML system, the internet matchmaking system, a computerized spreadsheet, a software based matchmaking system,
